(19) United States
(12) Patent Application Publication
(10) Pub. No.: US 2026/0350434 A1
(43) Pub. Date: Nov. 5, 2026

(54) DUAL-CHANNEL AI SYSTEM FOR STRUCTURAL COHERENCE THROUGH REFLECTIVE ALIGNMENT AND USER LOCALIZATION

(71) Applicant: Brian Gassman, Orinda, CA (US)

(72) Inventor: Brian Gassman, Orinda, CA (US)

(21) Appl. No.: 19/291,147

(22) Filed: Aug. 5, 2025

Related U.S. Application Data
(63) Continuation-in-part of application No. 19/219,303, filed on May 27, 2025, now abandoned.
Application No. 19/219,303 is a continuation-in-part of application No. 19/217,928, filed on May 23, 2025.
(60) Provisional application No. 63/799,664, filed on May 4, 2025.
(60) Provisional application No. 63/799,664, filed on May 4, 2025.
(60) Provisional application No. 63/804,649, filed on May 13, 2025.
(60) Provisional application No. 63/804,649, filed on May 13, 2025.

(51) Int. Cl. G06N 5/04; G06N 3/045

(52) U.S. Cl. CPC G06N 5/04; G06N 3/045

(57) ABSTRACT

A computer intelligence system enforces contextual alignment, between user task prompts and inference outputs through a dual-channel architecture comprising a coherence channel and an inference channel. Upon receiving a task prompt, the system requests and validates a multi-dimensional coherence snapshot from the user's device, comprising spatial, temporal, affective, relational, and purpose alignment data. A coherence module evaluates the snapshot against a coherence threshold to generate a validated coherence token. Inference generation is gated by a sync gating engine, which blocks output transmission unless the coherence token is verified and timely. Inference execution occurs in a memory-isolated transformer-based environment to preserve privacy and prevent context leakage. The architecture structurally enforces ethical, temporal, and contextual constraints before any response is released, providing a technical solution to coherence drift in AI systems by binding outputs to permissioned, real-time user context.

### REFERENCE TO RELATED APPLICATIONS

This application is a continuation-in-part of U.S. Non-Provisional patent application Ser. No. 19/219,303, filed on May 27, 2025, and entitled Dual-Channel AI System For Structural Coherence Through Reflective Alignment and User Localization, which is a continuation-in-part of U.S. Non-Provisional application Ser. No. 19/217,928, filed on May 23, 2025 and entitled Dual-Channel AI System For Structural Coherence Through Reflective Alignment and User Localization, which claims the benefit of and priority to U.S. Provisional Ser. No. 63/804,649, filed on May 13, 2025 and entitled Dual-Channel AI System For Structural Coherence Through Reflective Alignment, and U.S. Provisional Ser. No. 63/799,664, filed May 4, 2025 and entitled Dual-Channel AI System For Structural Coherence Through Reflective Alignment, the entire contents of each is hereby incorporated by reference.

This application claims the benefit of and priority to U.S. Provisional Application Ser. No. 63/804,649, filed on May 13, 2025, and entitled Dual-Channel AI System For Structural Coherence Through Reflective Alignment and User Localization, the entire contents of which is hereby incorporated by reference.

This application claims the benefit of and priority to U.S. Provisional Application Ser. No. 63/799,664, filed on May 4, 2025, and entitled Dual-Channel AI System For Structural Coherence Through Reflective Alignment and User Localization, the entire contents of which is hereby incorporated by reference.

### FIELD OF INVENTION

The present invention relates generally to artificial intelligence systems and, more particularly, to systems and methods for enforcing contextual coherence in AI-driven inference generation. In embodiments, the invention provides a multi-dimensional coherence validation framework that evaluates alignment between a user's real-time contextual state and a task prompt before permitting inference output delivery. The invention may be implemented in cloud-based, on-premises, or hybrid architectures and is applicable to a range of use cases involving safety-critical, privacy-sensitive, or ethically constrained AI interactions.

### BACKGROUND

Modern artificial intelligence (AI) systems can produce fluent, grammatically accurate responses to task prompts across a wide range of tasks. However, despite this fluency, current systems suffer from a fundamental structural limitation: they simulate coherence of the task prompt rather than require that the task prompt be validated for coherence before a response is generated and ultimately transmitted to an electronic device. That is, they give the appearance of understanding user intent and context but lack any underlying mechanism to validate or preserve that coherence in a verifiable, persistent manner.

This limitation arises because current systems are not architecturally designed to maintain validated alignment with a user's real-time cognitive, emotional, and contextual state. Instead, they rely on temporary techniques—such as prompt engineering, large token context windows, or manually stitched session memory—to simulate continuity across multiple interactions (e.g., between two or more task prompts). These approaches are brittle, and the simulated coherence degrades as user sessions (each session including one or more task prompts) grow in complexity, duration, or emotional nuance. Once the internal context window of an individual session is exceeded or the session resets, current systems lose any grasp of the user's validated context. The result is responses that sound plausible but are no longer aligned with the user's actual intent, needs, or prior interactions-a phenomenon often referred to as output drift. This drift is not incidental, but a predictable outcome of architectures that lack structural grounding mechanisms for coherence validation.

The limitation of current systems creates a technical problem: inference outputs are generated without any structural gating mechanism to ensure they remain coherent with a real-time snapshot of user-supplied signals (e.g., spatial identity, emotional tone, intent, and ethical alignment) that has been permissioned and confirmed by the current systems-often referred to as a validated state. Because coherence is not enforced structurally, the current systems have no way to determine whether it is producing outputs that are contextually appropriate or relationally consistent.

The absence of a structural gating mechanism introduces several challenges. For example, in safety-critical applications, the lack of coherence enforcement can result in dangerously misaligned outputs. In a healthcare setting, for instance, an AI system may respond to a user describing symptoms of distress or emotional urgency without validating the user's affective state or temporal immediacy. This disconnect can delay escalation, obscure risk, or contribute to patient harm, particularly when the current systems'fluency conceals its lack of situational awareness.

In multi-turn interactions, coherence drift can lead to internally inconsistent or contradictory outputs. For example, in a financial advisory or legal assistance tool, a user might initially supply information that frames the task within specific regulatory boundaries. If the current systems cannot structurally validate and preserve that context, it may later produce advice that conflicts with earlier constraints—creating risks of reliance on inaccurate or non-compliant guidance.

In contexts requiring ethical or access-based gating, the failure to validate coherence signals can result in the unauthorized release of sensitive or inappropriate content. For instance, a generative AI system lacking structural validation may respond to prompts from a user who lacks the necessary permissions, maturity level, or ethical context to receive a given output. Without verifying alignment signals such as user identity, emotional congruence, or contextual sensitivity, the current systems may inadvertently deliver harmful, age-inappropriate, or confidential content—posing reputational, legal, and safety risks.

In each of these cases, the system's fluency masks its structural incompetence, which can create a high-confidence failure mode. A high confidence failure mode confidently presented outputs conceal foundational misalignment with the user's real-time context.

In trust-based applications—such as therapy bots, relational agents, or educational tutors—systems that simulate coherence may appear continuous while lacking actual contextual memory. Without structural coherence validation, such systems cannot accurately preserve prior emotional signals, learning progress, or task-specific constraints. When users return expecting relational continuity, they may receive emotionally disconnected or uninformed responses, resulting in confusion, detachment, or erosion of trust.

Even in time-sensitive or location-dependent applications, the lack of validated coherence signals can cause functional misalignment. For example, a route-planning or logistics system may assume static context and issue recommendations based on outdated conditions—such as a previous spatial location or schedule—resulting in inefficiency or error. Without validated grounding in parameters like spatial identity or temporal signature, the current systems cannot confirm whether its outputs remain relevant.

It would therefore be beneficial to have a system that enforces coherence as a structural precondition to output generation. Such a system could validate incoming user signals—including real-time indicators such as spatial location, affective state, and intent—prior to inference or transmission. Structural gating based on validated coherence conditions could reduce drift, improve reliability, and enable high-trust deployment of AI current systems in complex, relational, or safety-sensitive environments. Incorporating such a framework would close the architectural gap in current systems by transforming coherence from an inferred behavior into an enforceable constraint—thereby improving alignment, enhancing user trust, and supporting fidelity in AI-driven interactions at scale.

### SUMMARY

In embodiments, a computer intelligence system comprises: a coherence enforcement module configured to: receive, from an input external electronic device via a coherence channel, a task prompt; determine, based on one or more attributes of the task prompt and predefined policy conditions, whether coherence validation is required; and upon determining that validation is required: generate a coherence snapshot request comprising a prompt for authorization of alignment data; and transmit, to the input external electronic device via the coherence channel, the snapshot request; memory operably connected to the coherence module, the memory configured to store a validated coherence token; a coherence module configured to: receive, from the input external electronic device via the coherence channel, a response to the snapshot request, the response comprising coherence signals comprising: a spatial identity parameter; a relational context parameter; a purpose alignment parameter; a temporal signature parameter; and an affective state parameter; validate the coherence snapshot by applying a multi-dimensional coherence determination to evaluate the coherence signals against task prompt context to determine that a coherence threshold is satisfied; and generate, based on the received coherence signals, a validated coherence token; and store the validated coherence token in the memory operably connected to the coherence module; a transformer-based neural network configured to: generate an inference output, in response to the coherence snapshot being validated, based on the task prompt; a deployment module configured to: execute the transformer-based neural network in a non-persistent, memory-isolated container to generate the inference output; and transmit the inference output to a sync gating engine; and a sync gating engine configured to: determine that the coherence snapshot associated with the task prompt has been validated by the coherence module; determine the coherence snapshot was validated within a predetermined amount of time; and transmit, to a recipient external electronic device via an inference channel, the inference output in response to determining the coherence snapshot is validated by the coherence module within the predefined amount of time, wherein the system operates using: the coherence channel configured to: receive task prompts from the input external electronic device; deliver the task prompts to the transformer-based neural network for processing; deliver coherence-related inputs from the input external electronic device to the coherence module; and deliver snapshot validation data from the input external electronic device to the coherence module, wherein the coherence channel prohibits release of the inference output generated by the inference channel unless coherence alignment conditions are satisfied.

In embodiments, the task prompt received via the input external electronic device comprises a natural language input, a multimodal input, or a combination thereof.

In embodiments, the task prompt includes multiple task prompts issued in sequence by the input external electronic device, each of the multiple task prompts satisfying the coherence alignment conditions.

In embodiments, the coherence enforcement module is further configured to detect contextual adjacency to a previously validated interaction, such that detection of the previously validated interaction causes the system to: generate a message comprising instructions to the input external device to initiate a coherence validation of the task prompt; and transmit, to the input external device, the message such that, upon receipt, the input external device initiates the coherence validation of the task prompt. analyze one or more historical interactions associated with the input external electronic device to determine whether coherence validation is required.

In embodiments, the spatial identity parameter comprises a three-dimensional coordinate representing a user associated with the task prompt, wherein the temporal signature parameter corresponds to metadata associated with the task prompt, and wherein the coherence module is further configured to determine physical grounding of the user and temporal grounding of the user prior to the coherence validation of the task prompt.

In embodiments, the coherence threshold is dynamically applied based on a sensitivity profile configured by the input external electronic device, wherein the sensitivity profile is associated with a user of the input external electronic device, wherein the sensitivity profile defines, user-permissioned parameters for gating, wherein the gating comprises: ethical gating, contextual gating, and emotional gating, and wherein the coherence validation criteria of the task prompt is based on at least the user-permissioned parameters.

In embodiments, the inference output comprises a response selected from a group consisting of: a text response; an executable instruction; a media asset; and a query reformulation.

In embodiments, the sync gating engine is further configured to inhibit transmission of the inference output when the coherence module fails to validate the coherence snapshot within the predetermined amount of time.

In embodiments, the sync gating engine is further configured to: determine that a second coherence snapshot associated with the task prompt has not been validated within the predetermined amount of time; and inhibit transmission of the inference output to the recipient external electronic device.

In embodiments, method for gated inference output in a computer intelligence system comprises: receiving, by a coherence enforcement module of the computer intelligence system from an input external electronic device via a coherence channel, a task prompt; determining, by the coherence enforcement module, based on one or more attributes of the task prompt and predefined policy conditions, coherence validation is required; generating, by the coherence enforcement module, a coherence snapshot request comprising a prompt for authorization of alignment data; transmitting, by the coherence enforcement module to the input external electronic device via the coherence channel, the coherence snapshot request; receiving, by a coherence module of the computer intelligence system from the input external electronic device via the coherence channel, a response to the snapshot request, the response comprising coherence signals including: a spatial identity parameter; a relational context parameter; a purpose alignment parameter; a temporal signature parameter; and an affective state parameter; generating, by the coherence module based on the coherence signals, a coherence snapshot, wherein the coherence snapshot is stored in memory operably connected to the coherence module; validating, by the coherence module, the coherence snapshot by applying a multi-dimensional coherence determination to evaluate the coherence signals against task prompt context to determine that a coherence threshold is satisfied; executing, by a deployment module of the computer intelligence system, a transformer-based neural network in a non-persistent, memory-isolated container to generate an inference output based on the task prompt; transmitting, by the deployment module to a sync gating engine of the computer intelligence system, the inference output; determining, by the sync gating engine, that the coherence snapshot has been validated by the coherence module; determining, by the sync gating engine, that the coherence snapshot was validated within a predetermined amount of time; and transmitting, by the sync gating engine to a recipient external electronic device via an inference channel, the inference output, wherein the method includes operating: a coherence channel configured to: receive task prompts and coherence-related inputs from the input external electronic device; deliver coherence signals and snapshot validation responses to the coherence module; and an inference channel configured to deliver the inference output to the recipient external electronic device, wherein the coherence channel constrains release of the inference output generated by the inference channel unless coherence alignment conditions are satisfied. In embodiments, the method further comprises analyzing, by the coherence enforcement module, at least one historical interaction associated with the input external electronic device to determine coherence validation is required. In embodiments, the method further comprises determining, by the sync gating engine, that a second coherence snapshot associated with the task prompt has not been validated within the predetermined amount of time; and inhibiting, by the sync gating engine, transmission of the inference output to the recipient external electronic device.

In embodiments, the task prompt received via the input external electronic device comprises a natural language request, a multimodal input, or a combination thereof.

In embodiments, the task prompt includes multiple task prompts issued in sequence by the input external electronic device, each of the plurality of task prompts either satisfying the coherence alignment conditions or being associated, via the input external electronic device, with a previously validated coherence snapshot.

In embodiments, the coherence signals spatial identity parameter comprises a three-dimensional coordinate representing a user associated with the task prompt, wherein the temporal signature parameter corresponds to metadata associated with the task prompt, and wherein the coherence module is further configured to determine physical grounding of the user and temporal grounding of the user prior to the coherence validation of the task prompt.

In embodiments, the coherence threshold is dynamically applied based on a sensitivity profile configured by the input external electronic device, wherein the sensitivity profile is associated with a user of the input external electronic device, wherein the sensitivity profile defines, user-permissioned parameters for gating, wherein the gating comprises: ethical gating, contextual gating, and emotional gating, and wherein the coherence validation criteria of the task prompt is based on at least the user-permissioned parameters.

In embodiments, the inference output comprises a response selected from a group consisting of: a text response; an executable instruction; a media asset; and a query reformulation.

In embodiments, the coherence enforcement module, coherence module, deployment module, transformer-based neural network, and sync gating engine are each implemented as containerized services within a distributed computing environment, wherein containerization enables separation of coherence enforcement from inference generation, and wherein containerization preserves structural integrity of the coherence validation associated with the task prompt.

In embodiments, the multi-dimensional coherence determination comprises evaluating the coherence signals according to: a spatial identity parameter; a relational context parameter; a purpose alignment parameter; a temporal signature parameter; and an affective state parameter, wherein each parameter is dynamically weighted based on one or more of the following: task type; user context; and a sensitivity profile associated with the input external electronic device.

In embodiments, a computer intelligence system comprises: a coherence module configured to: receive, via a coherence channel, coherence signals associated with a task prompt; generate a coherence snapshot based on the coherence signals; and validate the coherence snapshot using a multi-dimensional coherence determination, wherein the multi-dimensional coherence dimension is dynamically weighted based on one or more of the following: task type; user context; and a sensitivity profile associated with the input external electronic device; a transformer-based neural network configured to generate an inference output based on the task prompt in a memory-isolated container operably connected to the computer intelligence system; and a sync gating engine configured to: determine the coherence snapshot has been validated by the coherence module within a predetermined amount of time; and transmit the inference output to an external device via an inference channel, wherein the coherence enforcement module structurally blocks transmission of the inference output unless coherence alignment conditions are satisfied, wherein coherence alignment conditions comprise one or more of the following: ethical gating; temporal relevance; spatial grounding; affective congruence; and relational consistency as determined by the coherence module.

### BRIEF DESCRIPTION

Exemplary embodiments of the present invention will be described with references to the accompanying figures, wherein:

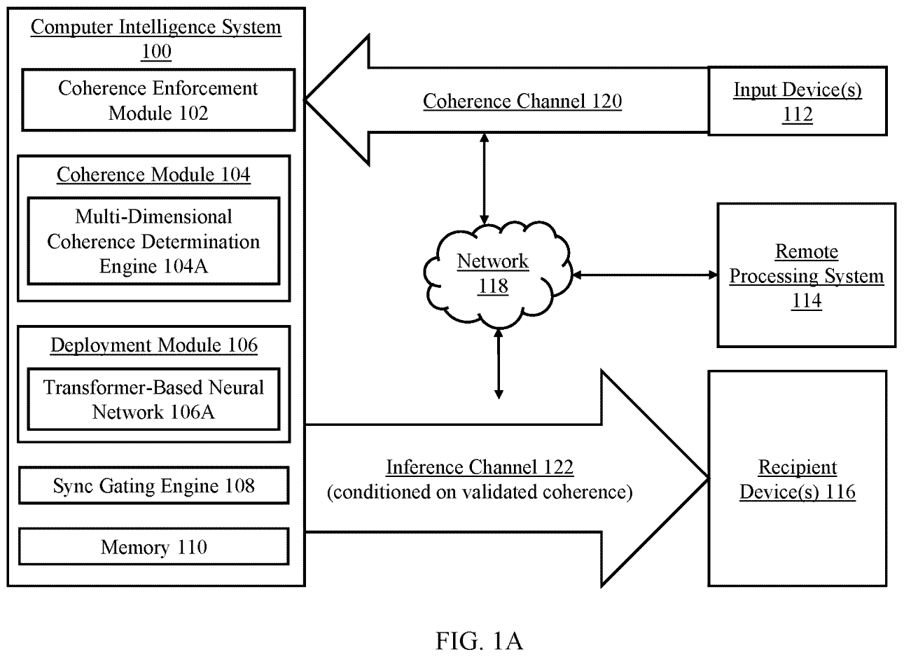

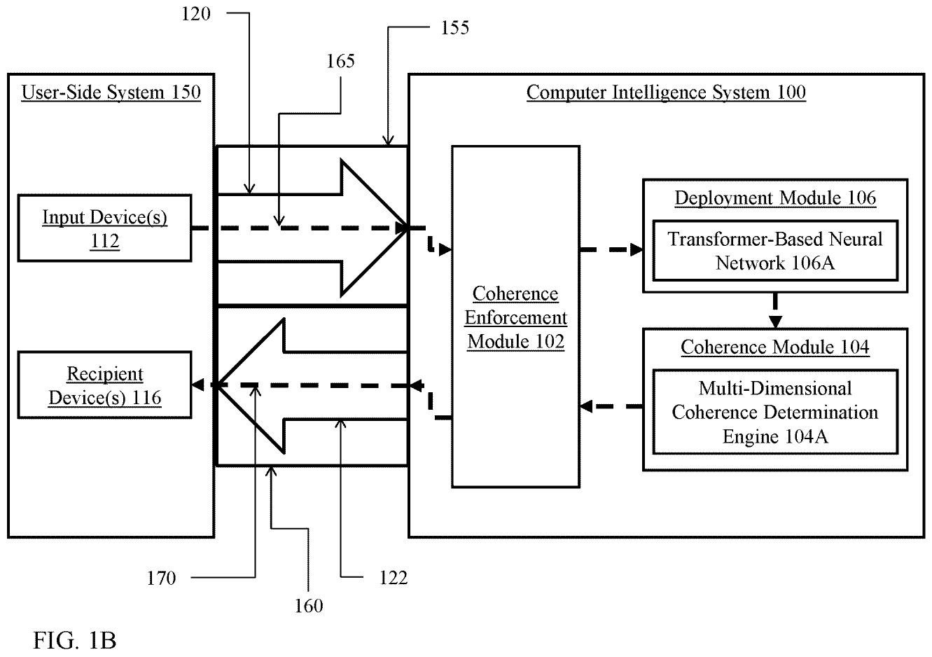

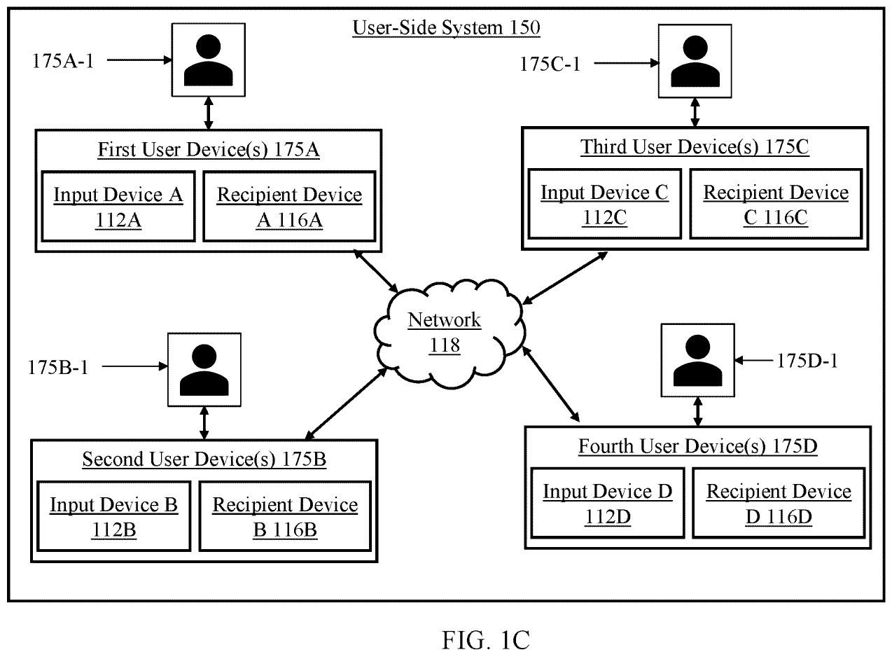

FIG. 1A is a system-level block diagram illustrating the modular architecture of computer intelligence system in accordance with various embodiments of the present invention;

FIG. 1B is an operational flow diagram showing the sequence of coherence validation and gated inference generation, in accordance with various embodiments of the present invention;

FIG. 1C is a block-diagram of a user-side system showing multiple user-device configurations, in accordance with various embodiments of the present invention

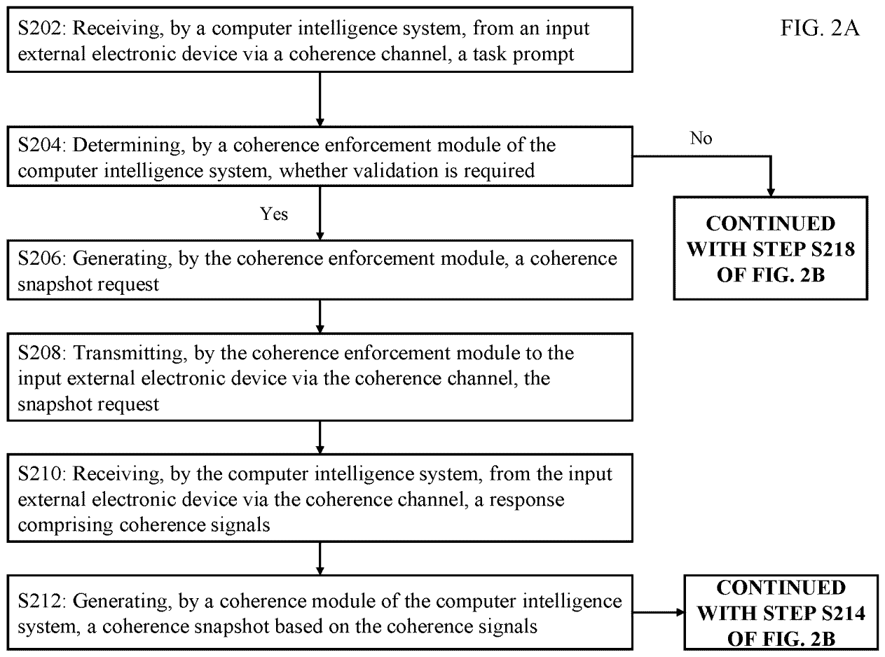

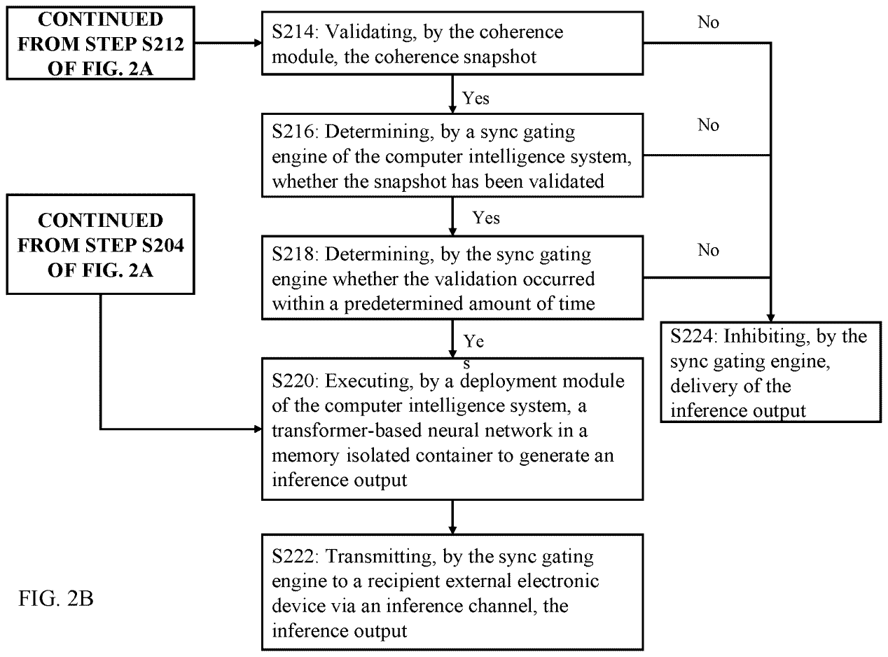

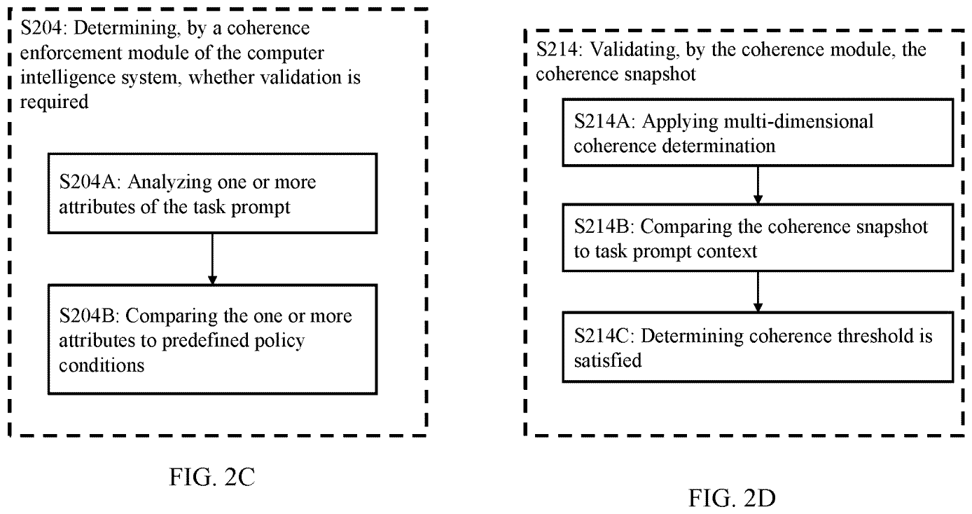

FIGS. 2A, 2B, 2C, and 2D are flow charts which illustrate a method for determining whether to conditionally generate and transmit an inference output based on coherence validation, in accordance with various embodiments of the present invention; and

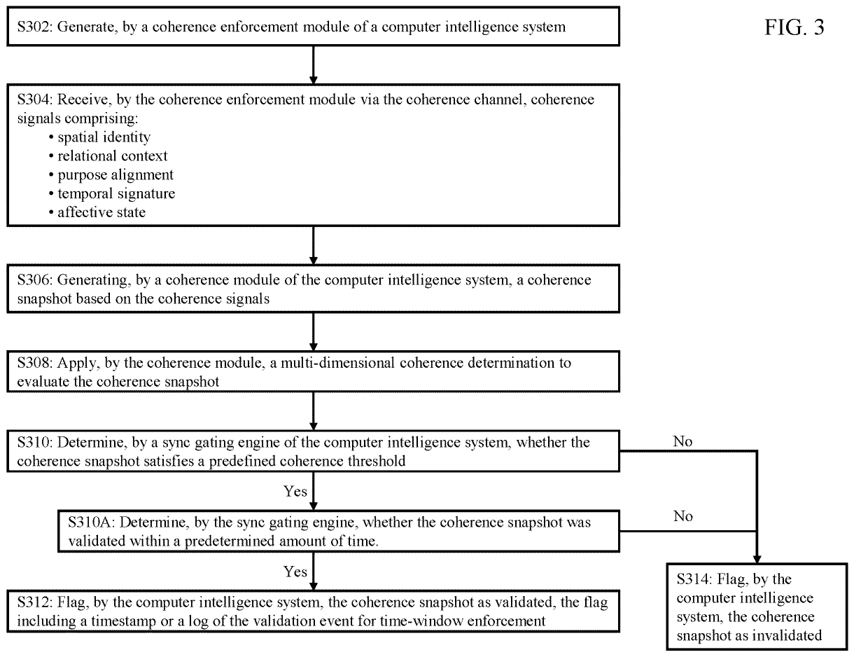

FIG. 3 is a flowchart illustrating an operational method for coherence snapshot validation and gating in accordance with various embodiments of the present invention.

### DETAILED DESCRIPTION

The present invention addresses the technical problem, namely, the lack of a technical mechanism to verify and enforce alignment between inference outputs and a user's real-time contextual state—a condition referred to herein as coherence drift—by requiring that task prompts be validated for coherence before a response is generated and transmitted to an external electronic device. More particularly, the present invention introduces a dual-channel coherence enforcement architecture that imposes structural constraints on inference delivery.

In embodiments, rather than relying solely on inference to respond to a task prompt, the present invention requires that a coherence snapshot, originating from a user device associated with the task prompt, be received, validated, and time-locked before an inference output may be generated or transmitted. In embodiments, the coherence snapshot may function as a new class of georelational data, encoding multi-dimensional alignment signals that reflect a user's spatial, temporal, affective, and relational context at a given interaction point. This georelational coherence snapshot may, for example, be formatted as a “relational shapefile” (.rshp), which would enable future integration with georelational database (.grdb) systems capable of storing, visualizing, and quality-assuring user alignment data across synthetic intelligence platforms. For example, the coherence snapshot may function as a form of georelational data configured to link user-originated alignment signals (e.g., spatial identity, affective state, relational context, to name a few) to a specific task interaction. The georelational data, in embodiments, enables the system to treat a user's contextual state as a mappable, queryable object, supporting substantially real-time validation and longitudinal coherence mapping.

In embodiments, the coherence snapshot is generated by the input external electronic device and transmitted to the system for validation. The coherence snapshot, in such embodiments, is configured to be transient, such that it is permissioned for single-use processing and, in embodiments, is not persistently stored by the system following completion of the inference task. In embodiments, anonymized structural metadata derived from the generated coherence snapshot, (e.g., spatial parameters, temporal parameters, affective parameters, relational alignment parameters, or a combination thereof, to name a few) may be retained by a Multi-Dimensional Coherence Determination Engine (MD-CDE). In such embodiments, the MD-CDE may include or interface with a Human Global Model (HGM) component configured to function as a Relational Neural Network (RNN). The HGM may use the structural metadata from the coherence snapshot as 5D Human Ground Control Points (HGCPs), enabling the HGM to incrementally construct a dynamic coherence map configured to support longitudinal alignment fidelity across a plurality of interactions, while remaining resilient to individual privacy settings such as incognito mode.

The coherence snapshot, in embodiments, comprises structured alignment signals including, for example, one or more of: spatial identity, temporal signature, affective state, relational context, and purpose alignment. These signals are evaluated using a multi-dimensional coherence determination process to assess alignment with the task prompt and generate a validated coherence token. The validated coherence token may include information reflecting the result of the coherence determination and metadata indicating whether the validation occurred within a predefined time threshold.

In embodiments, the present invention comprises a gating mechanism that receives the validated coherence token and structurally blocks transmission of any inference output unless coherence validation conditions are satisfied and the validation occurred within the permitted time window. This architecture, in embodiments, ensures that inference outputs are only generated and released when real-time alignment with the user's contextual state has been explicitly confirmed. For example, coherence is enforced as a structural precondition to output, not inferred post hoc.

The present invention delivers a technical solution to the coherence drift problem in part by introducing coordinated system components—which may include one or more of: a coherence enforcement module, a coherence module, a sync gating engine, and a transformer-based inference engine, to name a few—all of which may operate within one or more containerized execution environments that provide functional separation, security, and policy enforcement. In embodiments, modules of the present invention function across two channels: a coherence channel and an inference channel. The coherence channel, in embodiments, is configured to serve as a structured conduit for receiving permissioned user context and alignment signals. The inference channel, in embodiments, delivers validated inference outputs to external electronic devices. The coherence channel, in embodiments, may further operate as an ethical gating pathway. For example, the coherence channel may be configured to operate as an ethical gating pathway by ensuring that contextual alignment is explicitly authorized before output generation is permitted.

A user, in embodiments, initiates an interaction by submitting a task prompt from an input external electronic device via the coherence channel. The present invention evaluates whether coherence validation is required based on one or more of: predefined policies, task context, and historical interaction data, among others. If validation is required, the coherence enforcement module may generate and transmit a snapshot request, a permissioned prompt requesting alignment data, to the input external electronic device.

In response, the input external electronic device may transmit a structured coherence snapshot comprising multi-dimensional parameters such as, for example, spatial identity, temporal signature, affective state, relational context, purpose alignment, or combinations thereof. The coherence module may receive and process these parameters using a multi-dimensional coherence determination engine to confirm that a coherence threshold is satisfied. Upon successful validation, a coherence token is generated and stored.

Only upon meeting one or more conditions—such as successful validation, validation within a predetermined time period, or a combination thereof—does the present invention permit inference execution by the transformer-based model. The resulting inference output is generated and routed to the sync gating engine, which verifies the validated coherence token and blocks transmission via the inference channel unless the required coherence conditions are satisfied.

Accordingly, the present invention ensures that outputs in response to task prompts are structurally gated and contextually anchored. In embodiments, these outputs are aligned not merely at a syntactic level, but according to user-supplied coherence signals reflecting real-time (or substantially real-time) cognitive, emotional, and ethical context.

In certain embodiments, persistent memory does not reside in the model. Instead, coherence snapshots are permissioned, time-bounded, and transient—enabling preservation of user control and minimizing unauthorized context retention.

The present invention's dual-channel coherence gating framework introduces a novel architectural constraint for AI reliability: trust is not inferred—it is enforced. By structurally binding outputs to validated, permissioned user context, the present invention prevents drift and, in embodiments, enables context-sensitive, ethically aligned, and emotionally congruent responses. Furthermore, in embodiments, the present invention may enforce a strict one-way reflective channel. For example, the system may be structurally prohibited from writing, modifying, or injecting any data into the external electronic device associated with the user, which, in embodiments, may preserve user sovereignty and prevent manipulative feedback loops. Over a period of time, in embodiments, the aggregation of anonymized, validated coherence tokens enables the system to construct a generalized model of relational patterns, which enables the system to improve alignment fidelity across users without compromising individual privacy.

As used throughout, a coherence signal refers to structured, user-originated data that characterizes a user's real-time contextual state at the moment a task prompt is issued. A coherence signal may include one or more of the following: a spatial identity parameter (e.g., a GPS coordinate, IP geolocation, or indoor positioning vector representing the user's physical location); a relational context parameter (e.g., a session identifier, user affinity profile, or social proximity marker indicating interpersonal or historical relevance); a purpose alignment parameter (e.g., a declared task intent or system-deduced objective based on prompt content); a temporal signature parameter (e.g., a timecode, temporal token, or event clock indicating when the prompt was issued); and an affective state parameter (e.g., emotional tone derived from sentiment analysis, biometric input, or user tagging). Coherence signals may be explicitly supplied by the input device, inferred from ambient context, or derived from system interactions, and are evaluated collectively to determine whether the user's state is sufficiently aligned with the prompt to authorize inference generation and delivery.

As used throughout, a task prompt refers to a user-initiated input directed to computer intelligence system 100 for the purpose of eliciting a response, instruction, generation, or action from a transformer-based neural network. A task prompt may include natural language queries (e.g., “Summarize this document”), multimodal inputs (e.g., an image paired with text), executable requests (e.g., API calls or structured commands), or contextually derived signals (e.g., behavior-triggered prompts from wearable sensors or UI interactions). Task prompts may originate from one or more input devices, and may be accompanied by metadata or supplemental alignment data for coherence validation. In embodiments, a task prompt serves as the triggering mechanism for computer intelligence system 100's inference generation process and is evaluated for alignment with a corresponding coherence snapshot prior to inference execution or transmission.

In embodiments, computer intelligence system 100 encodes a structural alignment framework comprising context-localized tokens, user-gated activation channels, and coherence-derived model conditioning. Through these integrated components, in embodiments, computer intelligence system 100 enforces ethical inference boundaries and context decay, thereby enabling synthetic agents to generalize user intent without persistent profiling or behavioral mimicry. Computer intelligence system 100 is, in embodiments, configured to emphasize structural fit over inference scale, supporting long-term safety and adaptive fidelity in dynamic, human-centered environments.

Reference is made to FIGS. 1A through 1C, which illustrate embodiments of a system and method for enforcing coherence as a structural constraint in artificial intelligence-based inference systems. More particularly, the invention relates to computer intelligence system 100 configured to validate an input from an external device associated with a user's contextual state through a multi-dimensional coherence mechanism prior to generating and transmitting an inference output. In embodiments, computer intelligence system 100 may include one or more computing environments configured to validate task prompts for contextual coherence and to control inference generation and delivery. In embodiments, computer intelligence system 100 comprises modular components for one or more of the following: coherence enforcement, multi-dimensional signal analysis, gated inference generation, and secure output transmission, to name a few. Computer intelligence system 100 may, in embodiments, be implemented on one or more of the following a cloud-based server cluster, an on-premise AI appliance, or a hybrid edge-cloud architecture configured for responsive, privacy-preserving operation in safety-critical, user-sensitive environments, or a combination thereof, to name a few.

As shown in FIG. 1A, in embodiments, computer intelligence system 100 includes a plurality of functional modules, which may include coherence enforcement module 102, coherence module 104, a deployment module 106 comprising a transformer-based neural network 106A, a sync gating engine 108, and a memory 110 operably connected to one or more of the modules. These components, in embodiments, may be operably linked to an external input device(s) 112 and recipient device(s) 116, over network 118, via a coherence channel 120 and an inference channel 122, respectively. Communications between the computer intelligence system 100 and other networked components, such as remote processing system 114, are facilitated through a network 118.

In embodiments, coherence enforcement module 102 is configured to determine whether coherence validation is required for a given task prompt. This determination, in embodiments, may be based on attributes of the prompt or system policies. In embodiments, coherence enforcement module 102 initiates a coherence snapshot request with input device(s) 112 and communicates with input device(s) 112 to retrieve real-time alignment data. Coherence enforcement module 102, in embodiments, is configured to function as a primary decision layer responsible for triggering the gating process. In embodiments, coherence enforcement module 102 may include one or more of the following: policy engines, context history evaluators, or user-defined threshold evaluators to support customized enforcement strategies across use cases including ethics filtering, risk control, session continuity, or a combination thereof, to name a few.

Coherence Module 104, in embodiments, is configured to: (i) receive coherence signals associated with a task prompt; (ii) analyze those signals to determine whether they satisfy a predefined coherence threshold; and (iii) generate a validated coherence token based on the analysis. In embodiments, coherence module 104 may include multi-dimensional coherence determination engine 104A. In embodiments, coherence module 104 may be operably connected to multi-dimensional coherence determination engine 104A. Multi-dimensional coherence determination engine 104A, may, in embodiments, be operable to receive a plurality of alignment parameters. In embodiments, multi-dimensional coherence determination engine 104A, may be operable to perform structured evaluation across the plurality of alignment parameters. The plurality of alignment patterns, in embodiments, may include spatial identity, relational context, affective state, temporal signature, purpose alignment, or a combination thereof, to name a few.

In embodiments, spatial identity may refer to data that indicates a physical, virtual location, or a combination thereof associated with a user or associated user device (e.g., first user device(s) 175A, second user device(s) 175B, third user device(s) 175C, or fourth user device(s) 175D) at the time a task prompt is issued. This may, for example, include geolocation coordinates, Wi-Fi triangulation data, cellular tower ID, IP address geolocation, indoor localization signals (e.g., BLE beacons or RFID), or a combination thereof, to name a few. Spatial identity, in embodiments, enables grounding of task prompts to real-world contexts, zones of interaction, or a combination thereof, to name a few. For example, spatial identity may indicate or identify that a prompt originated from a hospital, home, classroom, or public space.

Relational context, in embodiments, refers to a user's (e.g., user 175A-1, 175B-1, 175C-1, or 175D-1) interpersonal or systemic relationship to other entities, environments, or prior interactions. For example, relational context may include, across multiple prompts, one or more of the following: session identifiers, user affinity clusters, social graph positioning, authorization roles, and continuity markers, to name a few. Relational context, may enable computer intelligence system 100 to determine whether the task prompt aligns with an ongoing dialog, historical pattern, or privileged role, such as, for example, distinguishing between a casual user and a trusted caregiver in a mental health application.

Affective state, in embodiments, may refer to an emotional, mood-based, or psychologically relevant signal associated with a user (e.g., user 175A-1, 175B-1, 175C-1, or 175D-1) associated with a task prompt received by the computer intelligence system 100. In embodiments, affective state may be determined based on the user's real-time emotional condition at or near the time the task prompt is submitted. Affective state, in embodiments, may be determined based on one or more of the following: sentiment analysis of user-submitted language, vocal tone extracted from speech input associated with the user, facial expression analysis via device camera associated with the user device(s) associated with the user, biometric signals such as heart rate variability or galvanic skin response (e.g., received from one or more electronic device(s) associated with the user), or explicit emotional tags provided by the user (e.g., selecting “frustrated” or “calm” in a UI displayed on the user device(s) associated with the user). These affective indicators may be evaluated individually or in combination to assess emotional congruence with the content and context of the task prompt.

The affective state, in embodiments, determines whether the emotional tone of the prompt is congruent with the computer intelligence system's 100 permissible response conditions. Permissible response conditions, in embodiments, refer to predetermined criteria (e.g., system-defined or user-configured criteria) that must be satisfied before a response may be generated or transmitted by the computer intelligence system 100. One or more of the permissible response conditions, in embodiments, are enforced by coherence validation mechanisms to ensure that the computer intelligence system's 100 response is contextually appropriate, ethically aligned, temporally relevant, and consistent with user permissions or application policies. In embodiments, permissible response conditions may vary based on the domain, sensitivity profile, or intended use case of the system. The following are examples of permissible response conditions: (1) Ethical gating (The task prompt and user context must comply with ethical constraints (e.g., no hate speech, age-inappropriate requests, or requests violating platform norms)); (2) User identity verification (The user's identity or relational status must be authenticated (e.g., only a clinician may receive diagnostic outputs)); (3) Temporal validity (The coherence snapshot must have been validated within a predefined time window (e.g., within the past 5 seconds)); (4) Emotional congruence (The user's affective state must be aligned with the nature of the requested output (e.g., no triggering content if distress is detected)); (5) Contextual continuity (the task prompt must relate to an ongoing or previously validated interaction (e.g., in a therapy session or tutoring flow)); (6) Permission scope compliance: The requested output must fall within the user's authorization or configured sensitivity profile (e.g., standard user vs. admin); (7) Geofencing alignment: The user's spatial identity must fall within a defined permissible zone (e.g., restricted content only available in regulated jurisdictions); (8) Purpose alignment: The task prompt must align with approved use cases or declared intent (e.g., system may block use for content scraping or adversarial testing); (9) Age verification: The system may require age-based gating to release content appropriate for minors or age-restricted services; (10) Safety context detection (In certain domains (e.g., healthcare, transportation), output may be withheld if real-time safety or risk parameters are triggered); and (11) a combination thereof. These conditions are enforced by the coherence module 104 and associated gating systems of the computer intelligence system 100 (e.g., the sync gating engine 108) prior to releasing any inference output via the inference channel 122.

Temporal signature, in embodiments, refers to time-based metadata linked to a task prompt. This includes, for example, timestamps (e.g., Unix time or ISO 8601 strings captured at prompt submission), latency measurements (e.g., round-trip delay between prompt issuance and snapshot receipt), time zone markers (e.g., UTC offsets or region-specific time zones such as “America/New_York”), temporal proximity to previous or scheduled interactions (e.g., elapsed time since last validated prompt or alignment with a pre-scheduled session window), and a combination thereof, to name a few. Temporal signature, in embodiments, ensures the coherence validation process incorporates at least one of the immediacy, staleness, or time-sensitive nature of the request, to name a few. For example, the temporal signature may enable computer intelligence system 100 to prioritize real-time navigation updates.

Purpose alignment, in embodiments, refers to the inferred or declared intent behind a task prompt, evaluated against system policy or user-configured permissions. This may involve semantic interpretation of prompt content, alignment with declared task objectives, detection of domain-specific constraints, or ethical screening (e.g., disallowing content generation for prohibited topics). Purpose alignment enables computer intelligence system 100 to determine whether the user's intended use of the inference output is congruent with system expectations and configured gating rules.

In embodiments, one or more of these signals—or a combination thereof—may be used to construct a coherence snapshot, which can serve as the contextual grounding mechanism for evaluating whether an inference output should be generated and transmitted.

Multi-Dimensional Coherence Determination Engine 104A, in embodiments, is operable within coherence module 104 to evaluate coherence signals across multiple dimensions. The multi-dimensional coherence determination engine 104A is configured to receive the plurality of parameters, and assess whether those parameters, individually or in combination, meet the coherence threshold. A coherence threshold, in embodiments refers to a predefined or dynamically adjustable alignment score that must be satisfied for a coherence snapshot to be considered valid. The coherence threshold represents the minimum degree of contextual congruence, across various alignment signals, required to authorize inference generation and transmission. In embodiments, the multi-dimensional coherence determination engine 104A dynamically weights each coherence signal according to one or more factors, including task type (e.g., high-stakes outputs such as medical advice or legal interpretation may require stricter alignment), user permissions (e.g., elevated privileges may reduce gating requirements or unlock broader inference scopes), real-time risk indicators (e.g., signals of emotional volatility, environmental instability, or potential misuse may raise the required threshold), and a combination thereof, to name a few.

This weighting process, in embodiments, enables the computer intelligence system 100 to modulate its sensitivity to different types of inputs based on context, configured to ensure that responses are gated with proportional rigor. Applications of this mechanism, in embodiments, may include threat detection systems (e.g., filtering potentially harmful outputs under crisis conditions), emotional grounding in mental health tools (e.g., withholding triggering responses when user distress is detected), access control in youth-directed systems (e.g., applying stricter coherence validation for users under a certain age or in educational settings), or a combination thereof, to name a few.

In embodiments, deployment module 106 is configured to execute a transformer-based neural network in response to validated coherence (e.g., via transformer-Based Neural Network 106A). In embodiments, deployment module 106 operates in a non-persistent, memory-isolated container that provides inference isolation and prevents leakage of user context beyond the active task window. For example, once the inference is generated, the container is terminated and no user-specific data is retained. As a result, continuing the example, each task prompt is processed in isolation, reducing the risk of unintended data carryover between sessions. Deployment module 106, in embodiments, may include one or more of the following: launch orchestration tools (e.g., Kubernetes job schedulers or serverless task managers), container security features (e.g., sandboxing protocols, read-only file systems, or runtime integrity checks), lightweight execution engines for real-time performance (e.g., WebAssembly runtimes or edge-deployable neural inference engines), or a combination thereof, to name a few. This design in embodiments, enables computer intelligence system 100 to maintain strict boundaries between validation and inference, configured for applications such as privacy-preserving chatbots, time-limited AI agents, and on-demand analysis tools, to name a few.

Transformer-Based Neural Network 106A, in embodiments, is a generative model configured to produce inference outputs based on a validated task prompt. In embodiments, the deployment module 106 may include the transformer-based neural network 106A. In embodiments, the deployment module 106 may be operably connected to the transformer-based neural network 106A. The transformer-based neural network 106A, in embodiments, may be pretrained or fine-tuned for domain-specific use, including natural language generation, multimodal synthesis, or decision support. Examples of transformer-based neural networks include autoregressive models, bidirectional encoders, or attention-based generative models configured for synthetic media, text-based coaching, or context-aware recommendation.

Sync Gating Engine 108, in embodiments, is configured to verify that a coherence snapshot associated with a task prompt has been successfully validated and that the validation occurred within a predetermined time window. In embodiments, when both conditions are satisfied—i.e., successful validation and timely validation—sync gating engine 108 may authorize delivery of the corresponding response (i.e., inference output). In embodiments, the computer intelligence system 100 may require one or more of successful validation of the task prompt and timely validation to be met prior to sync gating engine's 108 authorization of delivery of the corresponding response. In embodiments, sync gating engine 108 prevents output transmission if the validation has expired (e.g., not timely validated within a predetermined amount of time) or failed (task prompt could not be validated or would not be validated). Sync gating engine 108 is configured to ensure temporal integrity between task prompt and coherence signals, and, in embodiments, may be configured for support scenarios such as medical triage systems, autonomous system command gating, or financial decision release timing, to name a few.

Memory 110, in embodiments, is operably connected to coherence module 104 and is configured to store validated coherence tokens, transient context metadata, session indicators, or a combination thereof, to name a few. In embodiments, memory 110 is implemented as a volatile or semi-persistent memory system, configured to ensure validated signals can be referenced within a session without maintaining permanent identity data. Examples of memory 110 include ephemeral cache structures, session-scoped data buffers, or zero-retention memory environments designed for regulatory compliance and anonymized session analysis, to name a few.

Input Device(s) 112, in embodiments, are one or more electronic devices configured to provide task prompts and coherence-related data to computer intelligence system 100. In embodiments, input device(s) 112 may include one or more user-controlled electronic devices configured to capture natural language, biometric, geospatial, or multimodal signals for coherence evaluation. Examples of input device(s) 112 include one or more of smartphones, smartwatches, ambient sensors, AR headsets, VR input controllers, wearable affective monitors, and desktop chat clients, to name a few.

Remote Processing System 114 is configured to extend, parallelize, or offload portions of the coherence validation, inference generation, or data storage processes, to name a few. Remote processing system 114 may include cloud-based AI services, federated inference nodes, regulatory oversight interfaces, auxiliary computation resources, or a combination thereof, to name a few. Remote Processing System 114, may, for example, be used to provide fallback compute resources, audit logging, or compliance-aware second-pass validation in highly regulated environments.

Recipient Device(s) 116, in embodiments, are one or more electronic devices configured to receive inference outputs (i.e., responses) generated by transformer-based neural network 106A upon successful coherence validation of the response. Recipient device(s) 116 may include one or more of: mobile devices, embedded systems, voice assistants, visual displays, or haptic feedback endpoints. Examples of recipient device(s) 116, may include one or more of the following: smartphones, VR goggles, autonomous vehicle systems, wearable coaching devices, AI-driven prosthetics, or accessibility platforms for neurodivergent users, to name a few. In embodiments, one electronic device may account for input device(s) 112 and recipient device(s) 116.

Network 118, in embodiments, is configured to facilitate communication between components of computer intelligence system 100 including task prompts, coherence signals, and inference outputs, to name a few. Network 118 may include one or more of the following: the Internet, LAN, WAN, wireless mesh, 5G infrastructure, satellite uplinks, or secure private networks. In embodiments, network 118 supports low-latency, encrypted communication using TCP/IP, QUIC, or other transport protocols appropriate for user-sensitive data transfer, to name a few.

In embodiments, the coherence channel 120 is configured to receive task prompts and coherence signals, to name a couple. In embodiments, the coherence channel is configured to transmit snapshot requests. Coherence channel 120, in embodiments, is a dedicated logical channel configured to carry coherence-related communications between computer intelligence system 100 and external devices (e.g., input device(s) 112). In embodiments, coherence channel 120 may be a virtual conduit for task prompts, snapshot requests, alignment signals, and coherence validation results, to name a few. Coherence channel 120 may, in embodiments, be configured to enforce encryption, authentication, and timing constraints, to name a few. In embodiments, coherence channel 120 may include secure APIs, event queues, or WebSocket tunnels for synchronous coherence exchange, to name a few.

Inference channel 122, in embodiments, is a gated communication path configured to transmit inference outputs (i.e., responses to a task prompt) to a recipient device upon successful and timely coherence validation. In embodiments, the computer intelligence system 100 may require one or more of successful validation of the task prompt and timely validation to be met prior to sync gating engine's 108 authorization of delivery of the corresponding response via inference channel 122. In embodiments, inference channel 122 includes enforcement logic configured to prohibit a response transmission until coherence conditions have been met. The inference channel 122 may use rate limiting, token gating, policy enforcement, or content review layers, to name a few, to ensure outputs are contextually appropriate and legally compliant.

In embodiments, although Coherence Channel 120 and Inference Channel 122 are depicted as distinct communication paths in FIG. 1A, as noted in FIG. 1A, Inference Channel 122 may not operate independently; rather, in embodiments, Inference Channel 122 may only become active after computer intelligence system 100 has successfully validated coherence signals received from Input Device(s) 112 via Coherence Channel 120. Sync Gating Engine 108, in embodiments, may function as a structural gate that enforces the above dependency by permitting inference output to be transmitted via Inference Channel 122 only after a validated coherence token has been generated. In embodiments, Inference Channel 122 may be the final step in a gated coherence circuit, configured to ensure that inference outputs are grounded in validated, contextually appropriate user input.

Referring to FIG. 1B, an operational flow diagram is shown in accordance with various embodiments is shown. In embodiments, as illustrated in FIG. 1B, user-side system 150 includes input device(s) 112 and recipient device(s) 116. User-side system 150, in embodiments, is operably connected to computer intelligence system 100 over network 118. The flow begins when input device(s) 112 generate and transmit a first message 165 through ethical conduit input 155 and coherence channel 120 to computer intelligence system 100 via network 118. First message 165, in embodiments, comprises a task prompt and, in embodiments, may include a local coherence snapshot. As depicted by the hashed directional arrows in FIG. 1B, this message flow illustrates the sequence and direction of communication between system components. In embodiments, if first message 165 does not include a local coherence snapshot, computer intelligence system 100 may generate and send a coherence snapshot request to input device(s) 112,

Upon receiving first message 165, coherence enforcement module 102 may analyze the task prompt and associated data to determine whether coherence validation is required. The determination of whether validation is required, for example, may be based on policies or prompt-specific attributes, or a combination thereof, to name a few. If validation is triggered, coherence enforcement module 102 is configured to generate and transmit a coherence snapshot request to input device(s) 112, which, upon receipt of the coherence snapshot request, may generate transmit a local coherence snapshot to coherence enforcement module 102. In embodiments, the triggering of validation may initiate an internal processing sequence associated with the computer intelligence system 100. Coherence enforcement module 102, in embodiments, as exemplified in FIG. 1B, then transmits a second message to deployment module 106 to stage prompt execution.

In embodiments, the flow continues with deployment module 106 generating and transmitting a third message to coherence module 104. The third message, in embodiments, may include instructions such that, upon receipt of the coherence signals associated with the task prompt, coherence module 104 evaluates the coherence signals via multi-dimensional coherence determination engine 104A. the coherence signals may include one or more of: a spatial identity parameter, a relational context parameter, a purpose alignment parameter, a temporal signature parameter, and an affective state parameter. Multi-dimensional coherence determination engine 104A, in embodiments, compares these parameters against a coherence threshold to determine whether the prompt context meets alignment criteria. If the evaluation is successful, coherence module 104 generates a validated coherence token, which may be stored in memory 110. In embodiments, a validated coherence token may include structured metadata necessary to enforce alignment conditions and authorize response delivery. This metadata may include: a time of validation (e.g., a timestamp such as “2025-07-22T14:03:00Z” indicating when coherence was confirmed); a validation expiry or duration (e.g., a time-to-live field like “valid for 5 seconds” or an explicit expiration timestamp); a task prompt identification (e.g., a hash, UUID, or reference ID uniquely identifying the associated task prompt); a signal integrity score (e.g., a numerical or categorical value reflecting the strength of coherence alignment); snapshot metadata (e.g., anonymized indicators of spatial identity, affective state, and other signals used during validation, without storing raw user data); a sensitivity profile ID (e.g., a reference to a user-configured or system-assigned gating profile); a validation method or engine version (e.g., an identifier of the specific algorithm or configuration used by multi-dimensional coherence determination engine 104A); an issuer ID or module signature (e.g., metadata indicating which system instance or module issued the token, particularly in distributed deployments); and a combination thereof, to name a few. If unsuccessful, the coherence module 104 may generate a failed validation token. In embodiments, a failed validation token may be generated to document and communicate the outcome of an unsuccessful coherence check. The failed validation token may include structured metadata similar in form to a validated token, but reflecting conditions under which the coherence threshold was not satisfied. Such metadata, for example, may include one or more of: a time of validation attempt (e.g., a timestamp recording when coherence evaluation occurred); a failure reason code (e.g., identifiers such as “expired snapshot,” “incomplete signals,” or “threshold not met”); a task prompt identification (e.g., a UUID or hash linking the failure to a specific prompt); a signal mismatch profile (e.g., metadata indicating which coherence signals deviated from expected ranges); a rejection score or failure vector (e.g., a quantified summary of how far the input fell short of the coherence threshold); a sensitivity profile ID (e.g., the gating criteria or permissions applied during the failed evaluation); a snapshot reference ID (e.g., linking the failed attempt to a specific, unvalidated coherence snapshot); and a module signature (e.g., indicating the coherence module instance that issued the failure determination), to name a few. This metadata, in embodiments, may be logged for audit purposes, feedback loops, or downstream decisioning.

Once coherence validation is complete and a validated coherence token has been generated, in embodiments, as exemplified in FIG. 1B, deployment module 106 executes transformer-based neural network 106A to generate an inference output based on the validated task prompt. In embodiments, transformer-based neural network 106A operates within a non-persistent, memory-isolated container, ensuring that each inference is generated in isolation from prior interactions. The resulting inference output reflects the computer intelligence system's 100 context-aware response to the original task prompt from input device(s) 112, grounded in the validated coherence snapshot.

Following inference generation, as shown in FIG. 1B, in embodiments, the output is forwarded to sync gating engine 108. Sync gating engine 108, in embodiments, verifies that the coherence snapshot associated with the task prompt was both validated and validated within a predetermined temporal window. If both conditions are satisfied, sync gating engine 108 is configured to authorize the release of the output (response to the task prompt). In embodiments, the computer intelligence system 100 generates responsive message 170 based on the inference output. The responsive message, in embodiments, is transmitted via ethical conduit output 160 and inference channel 122 to recipient device(s) 116. This gated flow is configured to ensure that inference outputs are conditionally released based on structural validation of user alignment data, preserving contextual and ethical integrity throughout the transaction.

Referring to FIG. 1C, an embodiment of a user-side system 150 is shown comprising a plurality of user endpoints configured to interface with computer intelligence system 100 via network 118. The embodiment illustrates four exemplary user configurations, designated as first user device(s) 175A, second user device(s) 175B, third user device(s) 175C, and fourth user device(s) 175D. Each configuration includes a corresponding user—first user 175A-1, second user 175B-1, third user 175C-1, and fourth user 175D-1—who is operably connected to a dedicated input device(s) 112 (112A, 112B, 112C, 112D) and recipient device(s) 116 (116A, 116B, 116C, 116D), respectively.

Each user device is configured to independently generate and transmit task prompts and coherence-related signals to computer intelligence system 100. These communications, in embodiments, occur over network 118 using coherence channel 120 and inference channel 122, with coherence channel 120 supporting coherence validation workflows and inference channel 122 handling gated response delivery.

In embodiments, the coherence module 104 may process task prompts from each user device independently, applying multi-dimensional coherence determination engine 104A to assess coherence signals on a per-interaction basis. Optionally, coherence module 104 may reference historical coherence metadata from prior validated sessions to inform continuity assessments, subject to user-defined privacy constraints or session-specific permissions.

While FIG. 1C illustrates four user configurations for clarity of presentation, it will be understood that user-side system 150 is not limited to four users and each user is not limited to two devices. In embodiments, user-side system 150 is configured to support a scalable number of users, including hundreds or thousands of concurrently operating user devices, each capable of independently engaging in coherence-validated interactions with computer intelligence system 100. This configuration enables broad deployment across diverse use cases and environments, while maintaining structural validation integrity at scale.

FIGS. 2A, 2B, 2C, and 2D are flow charts which illustrate an operational method executed by computer intelligence system 100 for determining whether to conditionally generate and transmit an inference output based on coherence validation, in accordance with various embodiments of the present invention. In embodiments, the process involves receiving a task prompt, determining whether validation is required, gathering multi-dimensional coherence signals, generating a coherence snapshot, evaluating the snapshot for alignment against predefined coherence thresholds, and gating the inference output accordingly. Referring collectively to FIGS. 1A through 1C, a system architecture and operational environment are shown in accordance with various embodiments. The configuration, function, and interrelation of components depicted in these figures—including but not limited to computer intelligence system 100, coherence enforcement module 102, coherence module 104 and multi-dimensional coherence determination engine 104A, deployment module 106 with transformer-based neural network 106A, sync gating engine 108, memory 110, user-side system 150 comprising user devices 175A-D and corresponding users 175A-1-D-1, input devices 112A-112D, recipient devices 116A-116D, network 118, coherence channel 120, inference channel 122, ethical conduits 155 and 160, first message 165, and responsive message 170—are described in further detail above with respect to FIG. 1A-1C and are incorporated herein by reference in their entirety. These descriptions, in embodiments, provide foundational context for understanding the functional processes illustrated in the flowcharts of FIG. 2A-2D and other figures described herein. In embodiments, the systems and methods described herein provide a specific improvement to computer-based interaction systems by enforcing coherence validation through a structured gating architecture. In embodiments, computer intelligence system 100 implements a non-conventional framework, which comprises coherence enforcement module 102, coherence module 104, and sync gating engine 108. The non-conventional framework, in embodiments, is configured to ensure contextually and ethically appropriate responses. The above mentioned, alone and in combination, enable real-time, or substantially real-time, coherence analysis and conditional inference generation based on multi-dimensional signal evaluation. In embodiments, computer intelligence system's 100 architecture, including memory-isolated transformer execution (e.g., via deployment module 106) and enforcement of temporal constraints via sync gating engine 108, represents a technological solution to a technological problem, namely, for example, the contextual misalignment risks in automated response generation.

The process of FIGS. 2A-2D, in embodiments, may begin with step S202 of FIG. 2A. Referring to FIG. 2A. at step S202, a task prompt is received by computer intelligence system 100 from an input external electronic device (e.g., input devices 112) via coherence channel 120. In embodiments, the input device may be a smartphone, wearable sensor, voice-enabled assistant, or other user-side device configured to generate prompts. For example, a caregiver using a mobile health application on a smartphone may submit the task prompt “What emotional support message should I send to this child right now?” In embodiments, the coherence channel 120 may be a secure, policy-gated communication pathway supporting task submission and real-time metadata exchange.

The process of FIGS. 2A-2D, in embodiments, may continue with step S204. In embodiments, at step S204, the coherence enforcement module 102 of the computer intelligence system 100 determines whether validation is required. In embodiments, this determination is performed by a coherence enforcement module 102 and may be based on one or more factors such as the domain of the prompt, the user's identity or role, prompt sensitivity, or configured system policies, to name a few. Continuing the example, because the caregiver prompt concerns a child and relates to mental health, coherence enforcement module 102 may determine that validation is required before releasing any inference output. Coherence enforcement module 102 may determine that validation is not required when the prompt falls within predefined low-risk categories, such as factual queries, non-personal requests, or system-safe operations (e.g., asking for the weather, system uptime, or a definition). In embodiments, validation may also be bypassed when the user is operating within an active, previously validated session; when the user's identity or role is associated with elevated permissions; or when the prompt has been recently validated in near-identical form. Additionally, prompts originating from designated offline or asynchronous modes, or flagged as non-sensitive by the computer intelligence system 100 policy engine, may be exempt from validation to reduce latency and system overhead. These pathways enable the computer intelligence system 100 to flexibly conserve validation resources while maintaining a structured enforcement model where appropriate.

A more detailed description of S204 is located in the description of FIG. 2C. Referring to FIG. 2C, a detailed view of step S204 is shown. In embodiments step S204 may begin with step S204A. At step S204A, in embodiments, the coherence enforcement module 102 analyzes one or more attributes of the task prompt. These attributes may include, but are not limited to, the content type (e.g., factual inquiry vs. emotionally charged request), topic sensitivity (e.g., medical advice, child safety, or ethics-sensitive queries), prompt origin (e.g., submitted via a personal vs. institutional device, or from a geofenced jurisdiction), user role (e.g., anonymous guest, verified clinician, or administrator), prompt frequency (e.g., repeated or scripted queries), associated application domain (e.g., mental health, education, or entertainment), or a combination thereof, to name a few. Continuing the example, the module may detect that the caregiver's prompt involves a mental health context and is submitted via a personal device.

In embodiments, step S204 may continue with step S204B. At step S204B, the analyzed attributes are compared to predefined policy conditions. These conditions, in embodiments, may include ethics filters (e.g., rules prohibiting hate speech, misinformation, or age-inappropriate content), domain risk scores (e.g., assigning higher validation weights to prompts within sensitive fields such as healthcare, finance, or law), user-defined gating preferences (e.g., requiring stricter validation for child accounts or enabling relaxed gating in trusted enterprise environments), or a combination thereof, to name a few. If the attributes match the policy conditions, coherence validation is triggered. In embodiments, the computer intelligence system 100 initiates coherence validation when it determines that additional review is necessary based on the task prompt's attributes. This may occur, for example, when the task prompt includes sensitive content, originates from an unverified source, or falls under configured risk categories. If validation is not initiated, the computer intelligence system 100 proceeds directly to inference generation without performing coherence checks.

If validation is not required, the process bypasses the coherence validation sequence and continues directly with step S218 of FIG. 2B. However, if validation is required, in embodiments, the process continues with step S206 of FIG. 2A. Referring back to FIG. 2A, at step S206, the coherence enforcement module 102 generates a coherence snapshot request. In embodiments, this snapshot request instructs the user's input device to gather one or more coherence signals such as spatial identity (e.g., GPS coordinates), affective indicators (e.g., facial expressions or sentiment analysis), or temporal markers (e.g., session time or delay since last interaction), to name a few. Continuing the example, the caregiver's device may be prompted to collect emotional tags and location data to assess contextual appropriateness.

In embodiments, the process may continue with step S208. At step S208, the coherence enforcement module 102 transmits the coherence snapshot request to the input external device over the coherence channel 120 via a network which connects both the input external device and the system. This transmission, in embodiments, may include metadata identifying the prompt, system-specific snapshot parameters, constraints such as data freshness limits, and a combination thereof, to name a few. Continuing the example, the snapshot request may instruct the caregiver's mobile app to return current sentiment, last interaction time, and device location within five seconds.

In embodiments, the process may continue with step S210. At step S210, the computer intelligence system 100 receives, from the user's device, a response that includes one or more coherence signals via the coherence channel. In embodiments, these coherence signals may include structured or unstructured data representing spatial identity, relational context, affective state, temporal signature, and purpose alignment, to name a few. In embodiments, these coherence signals may include structured or unstructured data representing spatial identity, relational context, affective state, temporal signature, and purpose alignment, to name a few. Each of these signal types is described in greater detail above with respect to FIG. 1A, and that description is incorporated herein by reference as it applies equally to the coherence evaluation process described in connection with the present figures. Continuing the example, the mobile app associated with the caregiver's mobile device may return data indicating that the caregiver is at a school (spatial), has prior interactions with the child (relational), selected an “empathetic” tone (affective), is submitting within two minutes of the last message (temporal), and intends to support rather than diagnose (purpose).

In embodiments, the process may continue with step S212. At step S212, coherence module 104 generates a coherence snapshot based on the received coherence signals. In embodiments, the coherence snapshot may be constructed as a structured data object that represents user alignment across multiple parameters. This snapshot, in embodiments, may be retained temporarily in memory 110 and tagged with prompt metadata, timestamps, and validation context. Continuing the example, coherence module 104 may encode the user's location, tone, and session data into a multi-dimensional coherence snapshot associated with the original task prompt.

In embodiments, the coherence snapshot may be a structured representation of multi-dimensional user alignment data, which may be stored in memory 110 for subsequent evaluation. The snapshot, in embodiments, includes metadata associated with the original task prompt and coherence context, such as prompt ID, signal values, and input device ID. Additionally, the coherence snapshot may comprise one or more of the following: timestamp information indicating when the coherence signals were captured; signal source attributes (e.g., sensor type, device classification); signal confidence scores or normalization factors; session identifiers to group related interactions; validation status flags; and cryptographic hashes to ensure data integrity, to name a few. The coherence snapshot may be generated as a structured object (e.g., in the form of a JSON or protocol buffer construct, to name a couple) that maps each evaluated coherence parameter (e.g., spatial identity, affective state) to its measured or inferred value. In embodiments, the snapshot may also include a dimensional weighting profile that indicates the relative importance of each coherence factor based on task type or domain risk level. The generation process may be performed by coherence module 104 and may leverage internal schemas or templates tailored to specific application contexts, such as healthcare, education, or social support. Continuing the example, the snapshot generated for a caregiver's prompt may encode emotional tone as “empathetic,” location as “school,” timestamp as “10:47:23,” and device type as “mobile health app,” among other fields. This structured representation enables subsequent validation and gating decisions by downstream modules such as sync gating engine 108.

In embodiments, the process may continue with step S214 of FIG. 2B. Referring to FIG. 2B, at step S214, the coherence snapshot is validated by coherence module 104. This step includes evaluation of the alignment signals contained in the snapshot and comparison to predefined coherence requirements embodiments, this validation may involve evaluating whether affective tone, timing, and user intent are appropriate for the nature of the task prompt. Continuing the example, the computer intelligence system 100 may confirm that the user's “empathetic” tag, recent session activity, and role as caregiver are sufficient to authorize a supportive response.

A more detailed description of step S214 is located in the description of FIG. 2D. Referring to FIG. 2D, a detailed view of step S214 is shown. In embodiments, step S214 may begin with step S214A. At step S214A, the coherence module applies a multi-dimensional coherence determination process. In embodiments, this involves analyzing one or more parameters (e.g., such as spatial identity, affective state, and purpose alignment, to name a few) individually and in combination. Continuing the example, the computer intelligence system 100 may analyze whether the caregiver's physical location, emotional tone, and stated intent align with the prompt type associated with the task prompt.

In embodiments, step S214 may continue with step S214B. At step S214B, the computer intelligence system 100 compares the coherence snapshot to the context of the task prompt. This may include checking for logical alignment, temporal relevance, and emotional congruence, to name a few. In embodiments, semantic or rule-based engines may be used to evaluate the degree of contextual fit. In embodiments, the computer intelligence system 100 determines whether a coherence threshold has been satisfied. In embodiments, the coherence threshold is a weighted score calculated across multiple alignment parameters. As described in greater detail above with respect to FIG. 1A, and incorporated herein by reference, both the structure of the alignment parameters (e.g., spatial identity, relational context, affective state, temporal signature, and purpose alignment) and the dynamic weighting logic (e.g., based on task sensitivity, user privileges, or real-time risk signals) are evaluated by multi-dimensional coherence determination engine 104A within coherence module 104 to determine whether the coherence threshold is met. In embodiments, the evaluation process performed by multi-dimensional coherence determination engine 104A applies structured scoring logic to assess whether the combination of signals meets the required coherence threshold for inference generation. Continuing the example, the caregiver's “empathetic” tone and relationship to the user are found to align with the support-oriented nature of the prompt.

In embodiments, coherence validation may be performed without requiring a time-based component. For example, the computer intelligence system 100 may determine that a task prompt satisfies coherence requirements based solely on the alignment of non-temporal signals such as user identity, emotional tone, and relational context. In such cases, validation may be considered successful regardless of when the coherence snapshot was generated, so long as it remains contextually relevant and unaltered. This approach may be particularly applicable in asynchronous or low-risk environments, or in use cases where timing is not critical to ensuring a safe or appropriate response.

In embodiments, step S214 may continue with step S214C. At step S214C, the computer intelligence system 100 determines whether a coherence threshold has been satisfied. In embodiments, the coherence threshold is a weighted score across multiple parameters. Factors such as task type, user role, and risk context may influence how each parameter is weighted. As described in greater detail above with respect to FIG. 1A, and incorporated herein by reference, the alignment parameters and dynamic weighting logic applied during coherence threshold evaluation—such as increased emphasis on affective state or purpose alignment in sensitive contexts—are implemented by multi-dimensional coherence determination engine 104A within coherence module 104. Continuing the example, because the task involves emotional support for a minor, the computer intelligence system 100 may place extra weight on affective state and purpose alignment. If the aggregate score exceeds the defined threshold, the snapshot is deemed valid.

If the coherence snapshot fails validation, the process proceeds to step S224, where sync gating engine 108 inhibits the coherence snapshot. In embodiments, this may prevent the computer intelligence system 100 from generating or delivering a response. Continuing the example, if the coherence snapshot included a conflicting affective tone (e.g., “angry”) or an unverified user role, sync gating engine 108 may block response generation and issue a request for re-validation or correction.

In embodiments, the snapshot is successfully validated. In embodiments, the process continues with step S216 of FIG. 2B. Referring back to FIG. 2B, at step S216, the sync gating engine 108 verifies that the snapshot has been validated. This step includes one or more of checking the validation token, verifying the associated timestamp, confirming that the coherence snapshot originated from an authenticated input device, ensuring the token was issued by a trusted component of the computer intelligence system 100 (e.g., coherence module 104), validating the integrity of the snapshot data (e.g., via cryptographic signature or hash), or confirming that no intervening user state changes have occurred since validation, to name a few. Continuing the example, sync gating engine 108 may confirm that coherence module 104 issued a valid token less than ten seconds ago.

In embodiments, the process may continue with step S218. At step S218, sync gating engine 108 determines whether the validation occurred within a predefined time window. In embodiments, this ensures that stale or outdated snapshots are not used to authorize inference generation. Continuing the example, the computer intelligence system 100 may reject snapshots validated more than 30 seconds prior to task submission. If the snapshot is found to be outdated, the process may proceed to step S224, inhibiting further action.

In embodiments, the process may proceed with step S220. At step S220, deployment module 106 of the computer intelligence system 100 executes a transformer based neural network 106A in a memory isolated container to generate an inference output. In embodiments, the transformer based neural network 106A is configured to generate responses tailored to the validated prompt context and user alignment. Continuing the example, the model may produce an emotionally grounded message such as, “Tell them you're here for them and they're not alone,” based on the caregiver's tone and relational context.

In embodiments, the process continues with step S222. At step S222, sync gating engine 108 transmits the inference output to a recipient external electronic device via inference channel 122. In embodiments, inference channel 122 is a gated delivery path that enforces timing, ethical, and contextual safeguards before transmitting system responses. In embodiments, the inference output may be included in, or referred to as, a response. The response may include natural language text, audio output, image or video content, haptic feedback, any other modality generated by the computer intelligence system 100 based on the task prompt, or a combination thereof, to name a few. Continuing the example, the message is packaged in a responsive message and delivered securely to the caregiver's device via inference channel 122 and ethical conduit output 160.

In embodiments, the process may continue with step S224. At step S224, the sync engine inhibits the delivery of the inference output. The sync gating engine 108, in embodiments, inhibits the delivery based on one or more of an invalid coherence snapshot, an expired coherence snapshot, or an untrusted coherence snapshot, to name a few. The computer intelligence system 100 may initiate one or more protective actions in response to a coherence snapshot that either fails validation or is determined to be invalid due to expiration, tampering, policy conflict, or a combination thereof, to name a few. In embodiments, step S224 may be reached when the computer intelligence system 100 determines that coherence threshold conditions were not met (e.g., misalignment across key parameters), when the validation window has expired, when the snapshot was generated from an untrusted or unauthenticated source, or a combination thereof, to name a few. In embodiments, step S224 may include one or more of the following: rejecting the task prompt without generating a response; suppressing the inference output, even if it was generated prior to detecting a validation failure; displaying or transmitting an explanatory message to the user (e.g., “Unable to process request-validation required.”); prompting the user to resubmit the task prompt along with a new coherence snapshot; logging the failed attempt to a secure audit trail for future analysis or compliance; triggering a fallback response or escalating the task to a human reviewer, in high-stakes domains; updating system thresholds or user state flags based on repeated failures or anomalies; or a combination thereof, to name a few.

In embodiments, the steps of the process described above in connection with FIGS. 2A, 2B, 2C, and 2D can be rearranged or omitted.

Referring to FIG. 3, a flowchart illustrating an operational method for coherence snapshot validation and gating in accordance with various embodiments of the present invention. The method depicted may be performed, in whole or in part, by components of the computer intelligence system 100 described above with respect to FIG. 1A-1C and 2A-2D, which are incorporated herein by reference in their entirety.

In embodiments, the process illustrated in FIG. 3 may begin with step S302. At step S302, coherence enforcement module 102 of computer intelligence system 100 generates a request for coherence validation. In embodiments, this generation may occur automatically in response to task prompt attributes, such as high sensitivity, user risk classification, or domain-specific policy triggers. Continuing the example introduced previously, the caregiver prompt involving emotional support for a child may result in the automatic generation of a validation request.

In embodiments, the process illustrated in FIG. 3 may continue with step S304. At step S304, The coherence enforcement module 102 receives, via coherence channel 120, a set of coherence signals from a user-side input device. In embodiments, the received coherence signals may comprise structured or unstructured data corresponding to one or more of the following: (i) spatial identity (e.g., geolocation coordinates or device region); (ii) relational context (e.g., prior interactions, connection to subject); (iii) purpose alignment (e.g., intent of the user); (iv) temporal signature (e.g., timestamps, session history); and (v) affective state (e.g., tone or sentiment analysis), to name a few. Continuing the example, the caregiver's mobile app may transmit coherence signals indicating they are located at a school, are related to the child, selected an empathetic tone, submitted within 60 seconds of the prior message, and intend to provide emotional support.

In embodiments, the process illustrated in FIG. 3 may continue with step S306. At step S306, the coherence module 104 generates a coherence snapshot based on the received signals. In embodiments, the coherence snapshot may be a structured representation of multi-dimensional user alignment data, which may be stored in memory 110 for subsequent evaluation. The snapshot, in embodiments, includes metadata associated with the original task prompt and coherence context, such as prompt ID, signal values, and input device ID. Additionally, the coherence snapshot may comprise one or more of the following: timestamp information indicating when the coherence signals were captured; signal source attributes (e.g., sensor type, device classification); signal confidence scores or normalization factors; session identifiers to group related interactions; validation status flags; and cryptographic hashes to ensure data integrity, to name a few. The coherence snapshot may be generated as a structured object (e.g., in the form of a JSON or protocol buffer construct, to name a few) that maps each evaluated coherence parameter (e.g., spatial identity, affective state, to name a couple) to its measured or inferred value. In embodiments, the snapshot may also include a dimensional weighting profile that indicates the relative importance of each coherence factor based on task type or domain risk level. The generation process may be performed by coherence module 104 and may leverage internal schemas or templates tailored to specific application contexts, such as healthcare, education, or social support. Continuing the example, the snapshot generated for a caregiver's prompt may encode emotional tone as “empathetic,” location as “school,” timestamp as “12:47:23,” and device type as “mobile health app,” among other fields. This structured representation enables subsequent validation and gating decisions by downstream modules such as sync gating engine 108.

The process, in embodiments, may continue with step S308. At step S308, the coherence module 104 applies a multi-dimensional coherence determination process to evaluate the snapshot. In embodiments, this evaluation is performed by multi-dimensional coherence determination engine 104A, which analyzes the snapshot for internal consistency and contextual alignment. The engine may process each coherence dimension (e.g., spatial identity, relational context, affective state, temporal signature, and purpose alignment, to name a few) individually and in weighted combination to assess whether the overall signal profile reflects a coherent user-task relationship. The weighting of each dimension may, in embodiments, vary dynamically based on task category, system policy, prior user behavior, or a combination thereof, to name a few. For example, in high-sensitivity domains such as mental health or education, greater weight may be assigned to affective state and relational context, whereas in operational domains (e.g., logistics, finance), temporal and purpose alignment may be prioritized.

The coherence determination process may, in embodiments, involve calculating a numerical coherence score, applying semantic rules, invoking pattern-matching algorithms trained on historical interaction data, or a combination thereof, to name a few. In some embodiments, thresholds or banding logic may be applied to classify coherence as low, medium, or high, which may influence downstream validation or gating decisions. In embodiments, coherence determination engine 104A may compare the present snapshot against historical coherence profiles to assess continuity or detect anomalies. Continuing the example, the caregiver's signals may be scored for congruence with the task prompt's inferred intent (e.g., supporting a minor in distress) with particular attention given to their empathetic tone, established relationship to the recipient, and recent, consistent behavior across prior prompts. A strong alignment across these vectors may result in a high coherence score, qualifying the snapshot for validation in subsequent steps.

In embodiments, the process may continue with step S310. At step S310, sync gating engine 108 determines whether the coherence snapshot satisfies a predefined coherence threshold. In embodiments, the coherence threshold may be based on a weighted aggregation of the alignment scores. As described in greater detail above in connection with FIG. 2D and incorporated herein by reference, threshold criteria may dynamically vary based on task sensitivity, user role, and risk parameters. Continuing the example, because the prompt involves an emotionally vulnerable child, the coherence threshold may place greater emphasis on affective state and purpose alignment.

If the coherence snapshot fails to meet the threshold at step S310, the process may, in embodiments, continue with step S314. At step S314, the computer intelligence system 100 flags the coherence snapshot as invalidated. This flag, in embodiments, may be stored in association with the original task prompt, user session metadata, input device identifier, or a combination thereof, to name a few. In embodiments, the flag may be used to inhibit downstream operations such as inference generation or response delivery. In embodiments, the invalidation flag may include one or more of a variety of metadata fields, for example, a timestamp of the invalidation event, the reason code for invalidation (e.g., expired snapshot, failed threshold, untrusted source), a unique flag identifier, a reference to the triggering policy condition, and optionally, an escalation or retry counter, to name a few. The flag may also include a record of which coherence signals failed or were absent, and any relevant contextual notes added by the system (e.g., “emotional tone misaligned with prompt type”).

In embodiments, presence of an invalidation flag may initiate one or more automated system responses. These may include generating a user-facing message requesting updated coherence data, logging the failure event to a compliance or audit module, escalating the session to a human moderator in sensitive domains, adjusting system thresholds for future interactions with the same user or device, or a combination thereof, to name a few. Continuing the example, if the caregiver's coherence snapshot lacks a required affective tag or originates from a non-authenticated device, the system may apply the invalidation flag and transmit a secure message prompting the user to reattempt submission with complete alignment signals.

If the coherence snapshot satisfies the threshold, the process advances to step S310A, where sync gating engine 108 determines whether the snapshot was validated within a predetermined time window. This step, in embodiments, is configured to ensure temporal freshness and prevents stale coherence data from authorizing new responses. Continuing the example, the snapshot must have been validated within 30 seconds of task submission to remain valid. If the snapshot fails the timing requirement, the process may, in embodiments, proceed with step S314.

In embodiments, the process may proceed with step S312. At step S312, the snapshot is flagged as validated by the computer intelligence system 100. In embodiments, this flag may include one or more of the following: a timestamp, validation token, logging event that records the validation context for enforcement or auditing, to name a few. Continuing the example, sync gating engine 108 may log a validation event with a coherence token linked to the caregiver's session and store it for gated release enforcement.

In embodiments, the steps of the process described above in connection with FIG. 3 can be rearranged or omitted.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

What is claimed:

1. A computer intelligence system comprising:
a coherence enforcement module configured to:
receive, from an input external electronic device via a coherence channel, a task prompt;
determine, based on one or more attributes of the task prompt and predefined policy conditions, whether coherence validation is required; and
upon determining that validation is required:
generate a coherence snapshot request comprising a prompt for authorization of alignment data; and
transmit, to the input external electronic device via the coherence channel, the snapshot request;
memory operably connected to the coherence module, the memory configured to store a validated coherence token;
a coherence module configured to:
receive, from the input external electronic device via the coherence channel, a response to the snapshot request, the response comprising coherence signals comprising:
a spatial identity parameter;
a relational context parameter;
a purpose alignment parameter;
a temporal signature parameter; and
an affective state parameter;
validate the coherence snapshot by applying a multi-dimensional coherence determination to evaluate the coherence signals against task prompt context to determine that a coherence threshold is satisfied; and
generate, based on the received coherence signals, a validated coherence token; and
store the validated coherence token in the memory operably connected to the coherence module;
a transformer-based neural network configured to:
generate an inference output, in response to the coherence snapshot being validated, based on the task prompt;
a deployment module configured to:
execute the transformer-based neural network in a non-persistent, memory-isolated container to generate the inference output; and
transmit the inference output to a sync gating engine; and
a sync gating engine configured to:
determine that the coherence snapshot associated with the task prompt has been validated by the coherence module;
determine the coherence snapshot was validated within a predetermined amount of time; and
transmit, to a recipient external electronic device via an inference channel, the inference output in response to determining the coherence snapshot is validated by the coherence module within the predefined amount of time,
wherein the system operates using:
the coherence channel configured to:
receive task prompts from the input external electronic device;
deliver the task prompts to the transformer-based neural network for processing;
deliver coherence-related inputs from the input external electronic device to the coherence module; and
deliver snapshot validation data from the input external electronic device to the coherence module,
wherein the coherence channel prohibits release of the inference output generated by the inference channel unless coherence alignment conditions are satisfied.

2. The system of claim 1, wherein the task prompt received via the input external electronic device comprises a natural language input, a multimodal input, or a combination thereof.

3. The system of claim 1, wherein the task prompt includes multiple task prompts issued in sequence by the input external electronic device, each of the multiple task prompts satisfying the coherence alignment conditions.

4. The system of claim 1, wherein the coherence enforcement module is further configured to detect contextual adjacency to a previously validated interaction, such that detection of the previously validated interaction causes the system to:
generate a message comprising instructions to the input external device to initiate a coherence validation of the task prompt; and
transmit, to the input external device, the message such that, upon receipt, the input external device initiates the coherence validation of the task prompt.
analyze one or more historical interactions associated with the input external electronic device to determine whether coherence validation is required.

5. The system of claim 1, wherein the spatial identity parameter comprises a three-dimensional coordinate representing a user associated with the task prompt, wherein the temporal signature parameter corresponds to metadata associated with the task prompt, and wherein the coherence module is further configured to determine physical grounding of the user and temporal grounding of the user prior to the coherence validation of the task prompt.

6. The system of claim 1, wherein the coherence threshold is dynamically applied based on a sensitivity profile configured by the input external electronic device, wherein the sensitivity profile is associated with a user of the input external electronic device, wherein the sensitivity profile defines, user-permissioned parameters for gating, wherein the gating comprises: ethical gating, contextual gating, and emotional gating, and wherein the coherence validation criteria of the task prompt is based on at least the user-permissioned parameters.

7. The system of claim 1, wherein the inference output comprises a response selected from a group consisting of:
a text response;
an executable instruction;
a media asset; and
a query reformulation.

8. The system of claim 1, wherein the sync gating engine is further configured to inhibit transmission of the inference output when the coherence module fails to validate the coherence snapshot within the predetermined amount of time.

9. The system of claim 1, wherein the sync gating engine is further configured to:
determine that a second coherence snapshot associated with the task prompt has not been validated within the predetermined amount of time; and
inhibit transmission of the inference output to the recipient external electronic device.

10. A method for gated inference output in a computer intelligence system, the method comprising:
receiving, by a coherence enforcement module of the computer intelligence system from an input external electronic device via a coherence channel, a task prompt;
determining, by the coherence enforcement module, based on one or more attributes of the task prompt and predefined policy conditions, coherence validation is required;
generating, by the coherence enforcement module, a coherence snapshot request comprising a prompt for authorization of alignment data;
transmitting, by the coherence enforcement module to the input external electronic device via the coherence channel, the coherence snapshot request;
receiving, by a coherence module of the computer intelligence system from the input external electronic device via the coherence channel, a response to the snapshot request, the response comprising coherence signals including:
a spatial identity parameter;
a relational context parameter;
a purpose alignment parameter;
a temporal signature parameter; and
an affective state parameter;
generating, by the coherence module based on the coherence signals, a coherence snapshot, wherein the coherence snapshot is stored in memory operably connected to the coherence module;
validating, by the coherence module, the coherence snapshot by applying a multi-dimensional coherence determination to evaluate the coherence signals against task prompt context to determine that a coherence threshold is satisfied;
executing, by a deployment module of the computer intelligence system, a transformer-based neural network in a non-persistent, memory-isolated container to generate an inference output based on the task prompt;
transmitting, by the deployment module to a sync gating engine of the computer intelligence system, the inference output;
determining, by the sync gating engine, that the coherence snapshot has been validated by the coherence module;
determining, by the sync gating engine, that the coherence snapshot was validated within a predetermined amount of time; and
transmitting, by the sync gating engine to a recipient external electronic device via an inference channel, the inference output,
wherein the method includes operating:
a coherence channel configured to:
receive task prompts and coherence-related inputs from the input external electronic device;
deliver coherence signals and snapshot validation responses to the coherence module; and
an inference channel configured to deliver the inference output to the recipient external electronic device,
wherein the coherence channel constrains release of the inference output generated by the inference channel unless coherence alignment conditions are satisfied.

11. The method of claim 10, wherein the task prompt received via the input external electronic device comprises a natural language request, a multimodal input, or a combination thereof.

12. The method of claim 10, wherein the task prompt includes multiple task prompts issued in sequence by the input external electronic device, each of the plurality of task prompts either satisfying the coherence alignment conditions or being associated, via the input external electronic device, with a previously validated coherence snapshot.

13. The method of claim 10, further comprising:
analyzing, by the coherence enforcement module, at least one historical interaction associated with the input external electronic device to determine coherence validation is required.

14. The method of claim 10, wherein the coherence signals spatial identity parameter comprises a three-dimensional coordinate representing a user associated with the task prompt, wherein the temporal signature parameter corresponds to metadata associated with the task prompt, and wherein the coherence module is further configured to determine physical grounding of the user and temporal grounding of the user prior to the coherence validation of the task prompt.

15. The method of claim 10, wherein the coherence threshold is dynamically applied based on a sensitivity profile configured by the input external electronic device, wherein the sensitivity profile is associated with a user of the input external electronic device, wherein the sensitivity profile defines, user-permissioned parameters for gating, wherein the gating comprises: ethical gating, contextual gating, and emotional gating, and wherein the coherence validation criteria of the task prompt is based on at least the user-permissioned parameters.

16. The method of claim 10, wherein the inference output comprises a response selected from a group consisting of:
a text response;
an executable instruction;
a media asset; and
a query reformulation.

17. The method of claim 10, further comprising
determining, by the sync gating engine, that a second coherence snapshot associated with the task prompt has not been validated within the predetermined amount of time; and
inhibiting, by the sync gating engine, transmission of the inference output to the recipient external electronic device.

18. The method of claim 10, wherein the coherence enforcement module, coherence module, deployment module, transformer-based neural network, and sync gating engine are each implemented as containerized services within a distributed computing environment, wherein containerization enables separation of coherence enforcement from inference generation, and wherein containerization preserves structural integrity of the coherence validation associated with the task prompt.

19. The method of claim 10, wherein the multi-dimensional coherence determination comprises evaluating the coherence signals according to:
a spatial identity parameter;
a relational context parameter;
a purpose alignment parameter;
a temporal signature parameter; and
an affective state parameter,
wherein each parameter is dynamically weighted based on one or more of the following:
task type;
user context; and
a sensitivity profile associated with the input external electronic device.

20. A computer intelligence system comprising:
a coherence module configured to:
receive, via a coherence channel, coherence signals associated with a task prompt;
generate a coherence snapshot based on the coherence signals; and
validate the coherence snapshot using a multi-dimensional coherence determination, wherein the multi-dimensional coherence dimension is dynamically weighted based on one or more of the following:
task type;
user context; and
a sensitivity profile associated with the input external electronic device;
a transformer-based neural network configured to generate an inference output based on the task prompt in a memory-isolated container operably connected to the computer intelligence system; and
a sync gating engine configured to:
determine the coherence snapshot has been validated by the coherence module within a predetermined amount of time; and
transmit the inference output to an external device via an inference channel,
wherein the coherence enforcement module structurally blocks transmission of the inference output unless coherence alignment conditions are satisfied,
wherein coherence alignment conditions comprise one or more of the following:
ethical gating;
temporal relevance;
spatial grounding;
affective congruence; and
relational consistency as determined by the coherence module.
